(19) United States
(12) Patent Application Publication
(10) Pub. No.: US 2022/0261750 A1
(43) Pub. Date: Aug. 18, 2022

(54) MULTI-USE ASSET SYSTEM AND METHOD

(71) Applicant: GREYBLOOM BUSINESS DEVELOPMENT, MONTREAL (CA)

(72) Inventors: NAM NGUYEN, Montreal (CA); ALIN PETRESCU, Laval (CA); ASHBEEL JOHN, Montreal (CA); HICHAM MOUNIR, Sainte-Catherine (CA)

(21) Appl. No.: 17/650,946

(22) Filed: Feb. 14, 2022

Related U.S. Application Data
(60) Provisional application No. 63/200,085, filed on Feb. 12, 2021.

(51) Int. Cl. G06Q 10/08

(52) U.S. Cl. CPC G06Q 10/0833

(57) ABSTRACT

A method and system is disclosed a method and system for tracking a plurality of reusable item containers or assets comprising applying a unique permanent identification to each of the containers, populating a database with data related to each of the containers, wherein for each identified container the related data comprises the unique permanent identification and related static or dynamic data. During a container use stage: receiving an order from a consumer, selecting at least one of the containers and placing at least one ordered item in the selected container, shipping the packed container to a consumer, delivering the at least one shipped container to the consumer and returning the container, wherein a status and location of each of the containers is available upon request.

### CROSS REFERENCE TO RELATED APPLICATIONS

This application claims benefit, under 35 U.S.C. § 119(e) of U.S. provisional application Ser. No. 63/200,085 filed on Feb. 12, 2021 and which is incorporated herein in its entirety by reference.

### FIELD OF THE INVENTION

The present invention relates generally to an asset tracking system and method. In particular, the present invention relates to a multi-use container system and method.

### BACKGROUND TO THE INVENTION

Traditionally, information associated with a product is not centralized, production data remains with manufacturer partner/facility, shipment and inventory remains with warehouse facility and products are typically identified using printed labels which can be removed or wear out over time. What is need therefore, and an object of the present invention is the gathering of information of the products in a centralised source using a unique identification, allowing concerned parties to retrieve information without the necessity of requesting the data from a different party.

### SUMMARY OF THE INVENTION

In order to address the above and other drawbacks there is provided a method and system for tracking a plurality of reusable item containers throughout a container life span, comprising, during a container supply stage, applying a unique permanent identification to each of the containers, dividing each of the identified containers into one of a plurality of container sets, assigning each of the container sets to a respective one of a plurality of container users, populating a database with data related to each of the assigned containers, wherein for each identified container the related data comprises the unique permanent identification and related static or dynamic data, during a container use stage: receiving an item order from a consumer at a container user, the order comprising at least one ordered item, selecting at least one of the containers and packing the at least one ordered item in the at least one selected container, shipping the at least one packed container to the consumer, delivering the at least one shipped container to the consumer, returning the at least one received container, and receiving the at least one returned container at the container user, wherein a status and location of each of the containers in a container set assigned to a container user are available upon request from the assigned container user.

In some embodiments, returning the containers comprises refurbishing the containers.

In some embodiments, the returned containers are refurbished by the container user.

In some embodiments, the containers are supplied to the container user by a container supplier and the returned containers refurbished by the container supplier prior to the containers being received by the container user.

In some embodiments, the container comprises one of a reusable glass container or a reusable bag.

In some embodiments, the reusable container comprises one of a paper container, metal container, plastic container, glass container or container manufactured of other organic materials.

In some embodiments, the location further comprises a geographic location, and further wherein the geographic location is displayed as an icon on a map.

In some embodiments, the assigning further comprises branding each container of the container set according to its respective container user.

In some embodiments, each of the containers comprises a bar code, QR code, RFID or the like comprising the unique permanent identification and the updating comprises reading the bar code, QR Code, RFID or the like with a scanner, deriving the unique permanent identification from the bar code, QR Code, RFID or the like, accessing the database using the derived unique permanent identification and modifying at least one of a status or a location associated with the derived unique permanent identification.

In some embodiments, the container comprises a food container, and the item is an ordered food item and the consumer is a food consumer.

In some embodiments, packing the at least one ordered food item comprises placing the at least one ordered food item in a plurality of reusable containers and placing the plurality of reusable containers in a reusable bag and further wherein the unique permanent identification of each of the plurality of reusable containers is associated with the unique permanent identification of the reusable bag such that scanning the unique permanent identification of the reusable bag displays the unique permanent identification of the reusable containers in the reusable bag.

In some embodiments, the reusable container further comprises a display and further comprising displaying a summary of the at least one ordered food item on the display.

In some embodiments, the container or the display can be used to present a brand, a sponsor or other advertising or the like.

There is also provided a reusable container method. The method comprises selecting one of a plurality of containers, each of the containers comprising a unique permanent identification, placing a first item in the selected container, in a database, associating a description of the first item with the unique permanent identification of the selected container, using the unique permanent identification, accessing the database and displaying the associated description of the first item on a first display, removing the first item from the selected container, placing a second item in the selected container, in the database, associating a description of the second item with the unique permanent identification of the selected container, using the unique permanent identification, accessing the database and displaying the associated description of the second item on a second display.

Also, there is provided a reusable container method. The method comprises selecting a plurality of primary containers, each of the primary containers comprising a unique permanent identification, placing an item in each of the selected primary containers, in the database, associating a unique permanent identification of a given one of the selected primary containers with a description of the item placed in the primary given container, placing each of the selected primary containers in secondary container, the secondary container comprising a unique permanent identification, in the database, associating the unique permanent identification of the secondary container with the descriptions of each of the items in each of the selected primary containers, using the unique permanent identification of the secondary container, accessing the database and displaying the descriptions of each of the items in each of the selected primary containers.

### BRIEF DESCRIPTION OF THE DRAWINGS

FIG. 1 provides a schematic diagram of an overview of a multi-use container system in accordance with an illustrative embodiment of the present invention;

FIG. 2 provides a schematic diagram of a multi-use asset system in accordance with a general illustrative embodiment of the present invention;

FIG. 3 provides a schematic diagram of a multi-use container system in accordance with an illustrative embodiment of the present invention;

FIG. 4 provides a schematic diagram of a multi-use container method in accordance with an illustrative embodiment of the present invention;

FIG. 5 provides a front plan view of a dashboard in accordance with an illustrative embodiment of the present invention;

FIG. 6 provides a front plan view of an application in accordance with an illustrative embodiment of the present invention; and.

FIG. 7 provides a front plan view of an information display in accordance with an illustrative embodiment of the present invention.

### DETAILED DESCRIPTION OF THE ILLUSTRATIVE EMBODIMENTS

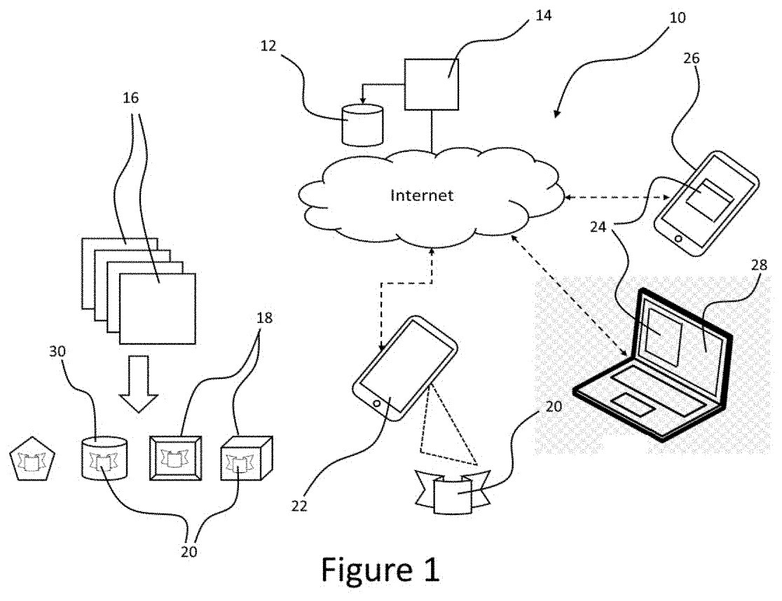

Referring to FIG. 1, an asset management system 10 will be described which may in part be hosted on-premise or as part of a cloud based solution. The system 10 comprises a centralised repository or asset database 12 with a defined Data Owner (DO) 14 with access to one or more intelligent factories 16. The intelligent factories 16 comprises supplier data connected through digital labels, factory display units. The system 10 further comprises trackable/traceable assets 18, which could include but are not limited to IoT controllers and sensors, medical devices and equipment, food containers, reuseable bags, packaging, pallets, and the like. Data provided by the intelligent factories and trackable assets is stored in the asset database 12 and used to create business metrics to monitor improvements as well as to provide for asset tracking.

Still referring to FIG. 1, a means for tracking/tracing assets 18 is provided comprising a unique permanent identification 20 in the form of a code or the like to identify the asset 18. The unique permanent identification 20, or “Birth Certificate”, comprises, for example, a barcode, QR code, RFID or the like, which provides the unique permanent identification 20 throughout the life of the asset/product 18. As will be discussed in more detail below the unique permanent identification 20 can, for example, be scanned using a scanning device 22 (such as a smartphone equipped with a QR code reading application or the like) and the unique permanent identification 20 stored together with other data related to the asset 18 in the asset database 12.

Still referring to FIG. 1, in order to access data held in the asset database 12, an application, or app, 24 running on a smartphone 26 or a web browser 28, or the like. Various levels of user access may be provided to the database 12 via an authentication process. Each access to the asset database 12 is illustratively timestamped and geolocated, for example using Global Positioning System (GPS) data collected from the smartphone 26, and may also be encrypted if so required. This access is provided to parties through an Application Programming Interface (API) access, with the DO 14 defining access control levels from a centralized control.

Still referring to FIG. 1, asset related data held within the asset database 12 can illustratively be labelled as 1) factory (internal use only), 2) general use (such as label information), 3) data available to sell for data analytics (data for improving services) or 4) pay per use access. Additionally, other financial models may be defined as per the needs of a customer. The DO 14 may in one embodiment trade data, for example, in exchange for other data with partners or sell data to mobile/web application developers to create new uses. In other embodiments, each access to the asset database 12 API is registered as a transaction with the option of tying in data to business's financial metrics. Authentication of the user is completed at a device level. For instance, where the device is a mobile phone 26 which is authenticated where the user has agreed to the terms and conditions for the use of the device. With each scan, the ownership of the asset 18 is allocated to the owner of the device scanning it and carries out a predetermined cycle. In a given embodiment, and as will discussed in more detail below, an asset 18 can comprise a container 30 wherein in some embodiments the container 30 is adapted for receiving one or more assets 18. In this regard, each of the containers 30 are identified with a respective unique permanent identification 20, and as such can be tracked as an asset 18.

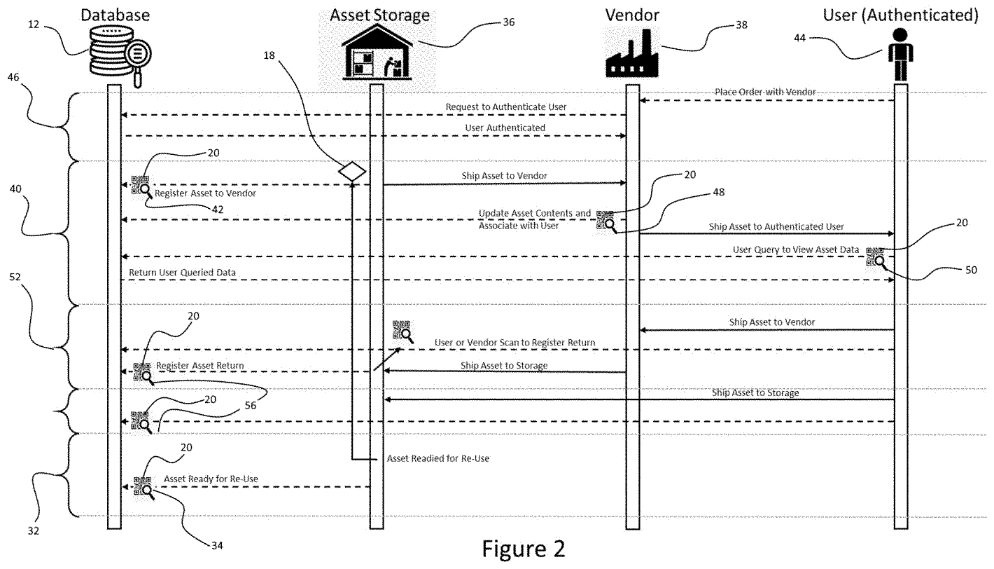

Referring now to FIG. 2 in addition to FIG. 1, prior to use, assets 18 are prepared for use at a preparation for use stage 32. This could be, for example initial preparation of freshly manufactured assets or refurbishment of assets already in use within the system, for example by cleaning or the like. The assets are subsequently indicated as ready for use within the asset database 12, for example by scanning the unique permanent identification 20 of the prepared asset 18 with a “ready for use” scanner 34. The prepared assets 18 are then typically then placed in storage 36 ready for shipping to one or more vendors 38 as part of the asset delivery cycle stage 40 and at which point their allocation to a given vendor is registered in the asset database 12, for example by scanning the unique permanent identification 20 of the asset 18 with a register asset to vendor scanner 42. In a particular embodiment, both the refurbishment and storage 36 could be co-located with the vendor 38.

Still referring to FIG. 2, a user 44 placing an order with a vendor for content such as a product or the like (not shown) to be shipped from the vendor 38 using an asset 18, is first authenticated at an authentication stage 46. Once authenticated, the vendor content is placed within the asset 18. The asset database 12 is then updated, for example by scanning the unique permanent identification 20 of the asset 18 with a vendor asset content scanner 48 and in order to associate the unique permanent identification 20 of the asset 18 with data descriptive of the content of the asset 18, for example a product description, source description of the content and the like.

Still referring to FIG. 2, the asset 18 is the shipped together with the vendor content to the user 44. The user 44 may query the asset database 12 to view the data descriptive of the content of the asset 18, for example by scanning the unique permanent identification 20 of the asset 18 using a user scanner 48. The user scanner 50 can be provided by, for example, an app running on a smart phone or the like (not shown), which accesses the asset database 12 and retrieves the data descriptive of the content for display to the user 44.

Still referring to FIG. 2, in a first embodiment of a return cycle 54, the asset 18 is returned to storage 36 via the vendor 38. The asset database 12 is then updated to indicate that the asset 18 has been returned and is ready for refurbishment, for example by scanning the unique permanent identification 20 of the asset 18 with a ready for refurbishment scanner 56. In a second embodiment of a return cycle 54, the asset 18 is returned to directly storage 36 by the user 44. The asset database 12 is then updated to indicate that the asset 18 has been returned and is ready for refurbishment, for example by scanning the unique permanent identification 20 of the asset 18 with the ready for refurbishment scanner 56.

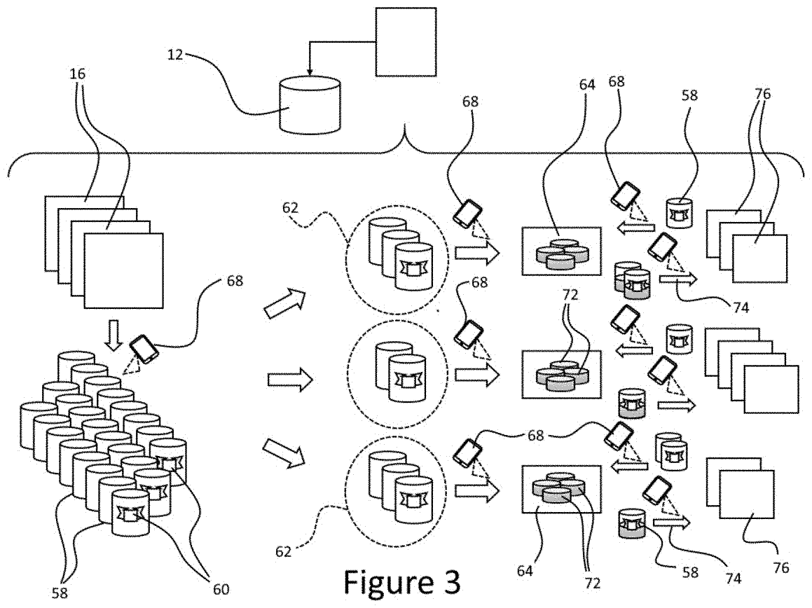

Referring now to FIG. 3, in a particular embodiment, the traceable assets 18 are containers 58 comprising one of traceable glass containers 60 and traceable multi-user bags (not shown), although other reusable containers such as those manufactured from paper, plastic, metal or other organic materials could also be used. As discussed above, the traceable assets 18 in the form of containers 58 are labelled with the unique permanent identification 20, for example during manufacturing. The unique permanent identification 20 is entered into the asset database 12 for example as part of the manufacturing process. Other information might also be included in the asset database 12 comprising for example date of manufacture, asset type and the like.

Still referring to FIG. 3, the containers 58 are divided into a plurality of container sets 62 which are each subsequently assigned to one of a plurality of container users. During the assigning process the unique permanent identification 20 together with related data such as the assigned container user, status of the container, current location and the like can be used to populate the database 12. In this regard, the unique permanent identification 20 may be scanned by a scanning device 22 as part of the procedure for populating the database 12. The assigning process may also include branding the containers according to their assigned container user.

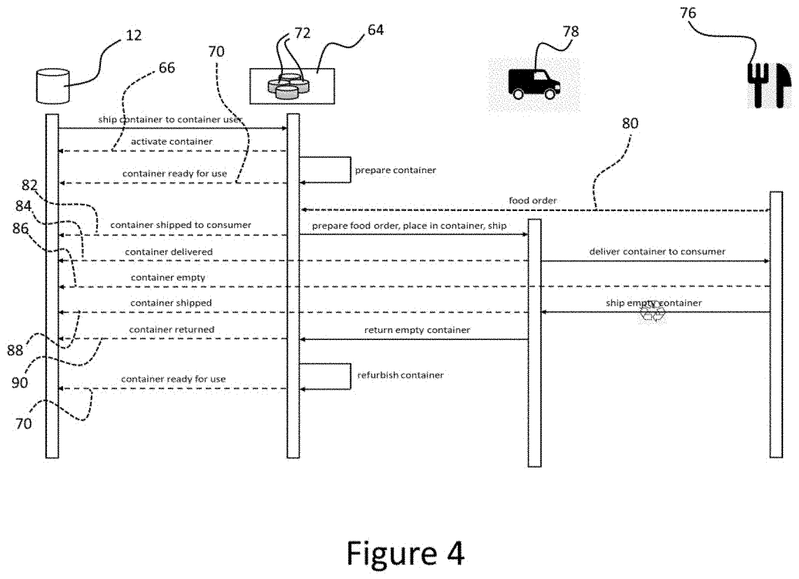

Referring to FIG. 4 in addition to FIG. 3, the containers 58 are illustratively subsequently suppled to their assigned container user 64. On reception the database 12 is updated such that the entry associated with the containers 58 is activated 66 and the containers 58 ready for use, for example by scanning the unique permanent identification 20 using a suitable scanning device 68 and adding additional information as necessary. At this point the containers 58 may be subject to additional measures to prepare them for use, for example by washing the containers 58, quality control to identify defects or the like, following which the database 12 is updated such that the entry associated with the containers 58 is ready for use 70.

Still referring to FIGS. 3 and 4, in a particular embodiment, the container users 64 comprise a plurality of factory kitchens 64. The factory kitchens 64 prepare food items 72 for shipping 74 to ordering ones of a plurality of food consumers 76 within one or more of the containers 58 using a shipper 78 and based on a food order 80 which is transacted through the system. In this regard, the containers 58 illustratively comprise reusable containers onto which the unique permanent identification 20 has been engraved and/or reusable bags or the like. Food items 72 are prepared by the factory kitchens 64 based on food orders received from the food consumer 76. One or more containers 58 which are ready for use are selected and a prepared food order packed therein for shipment to the food consumer 76 by the shipper 78. In a particular embodiment deposit for the container(s) 58 might be added to the food order. On shipping the database 12 is updated such that the entry associated with the container(s) 58 indicates shipped 82 or in transit or the like. In this regard, additional information can be included in the update, for example cultural background of the meal, name in original language, ingredients, nutritional facts, reheating instructions, serving suggestions, beverage pairings and the like. The container and contents are also illustratively updated indicate the container 58 and contents are now the property of food consumer 76, who is assigned ownership of the container 30 either through a consignment fee or registered account with necessary insurances.

Still referring to FIGS. 3 and 4, on delivery to the food consumer 76 the database 12 can be updated such that the entry associated with the container 58 is delivered 84. Subsequently, once the delivered container 58 is empty, the database 12 can be updated such that the entry associated with the container 58 is empty 86, which in turn can be used to prompt the shipper 78 to retrieve the container(s) 58 from the food consumer 76. On return via the shipper 78 the database 12 is updated such that the entry associated with the container(s) 58 indicates shipped 88 or in transit or the like. On return the database 12 can be updated such that the entry associated with the container 58 is returned 90. This can also be used as prompt for the removal of any additional information, for example the cultural background of the meal, etc., associated with the food order sent previously using the container 58. At this point the containers 58 may be subject to additional measures to refurbish the containers 58 such that they are ready for use, for example by washing the containers 58, quality control to identify defects or the like, following which the database 12 is updated such that the entry associated with the containers 58 is ready for use 70.

In the event the containers 58 comprise multipurpose bags, as these items are typically not microwavable, additional options can be provided for such as built in weight sensors that are linked to the sales order/work order details to ensure correct meal combinations are prepared for delivery, and upon return of containers, estimates of the number of containers based on their weights, a display (such as an OLED display or Kindle technology) to display advertisements depending on the sponsors and content in the bag, a lock that is only unlocked upon the scan of a mobile device with the correct authentication code, GPS location, cooling or heating devices; and the like (all not shown).

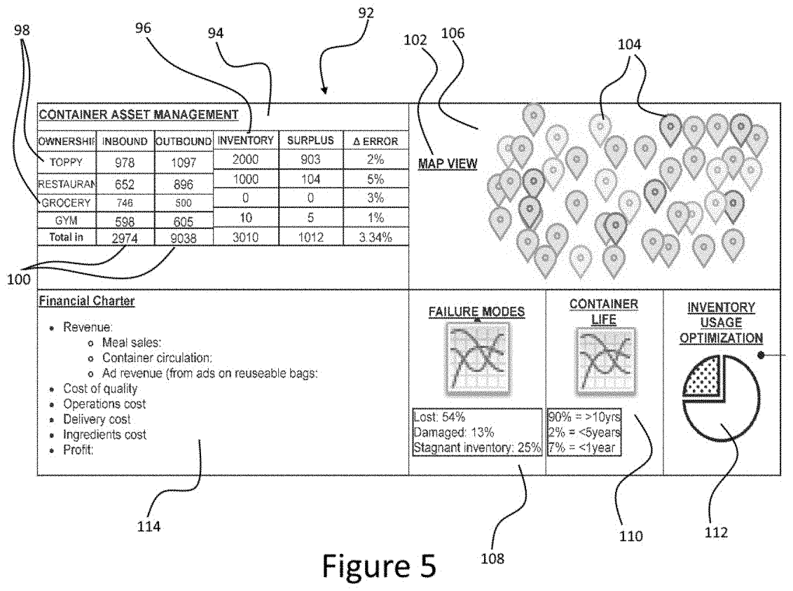

Referring now to FIG. 5 in addition to FIG. 1, a dashboard 92 is provided, for example via a website (not shown) such that on access to the database 12, data associated with all or a subset of the traceable assets 18 can be reviewed. In an exemplary embodiment the dashboard 92 comprises data related to the traceable assets 18 displayed in a tabular form 94, comprising inter alia current inventory 96, location of inventory 98 and status of inventory 100. Data displayed in the table could be filtered to limit the display to a given time frame, container user 64 or the like.

Still referring to FIG. 5, additionally data associated with all or a subset of the traceable assets 18 is displayed on a map 102, for example using icons 104 displayed on a map 106. The icons 104 may be colour coded to provided additionally information based on a selected filter, such as location (e.g. green=at factory 16, red=at container user 64, such a factory kitchen, yellow=with consumer 76, etc.) or age of unused containers 58 or the like (e.g. green<2 weeks, yellow<4 weeks, red>4 weeks, etc.). Charting is also included to provide statistics regarding inventory status 108, container life 110 and inventory usage 112. A menu 114 is also provided to access additional views (not shown).

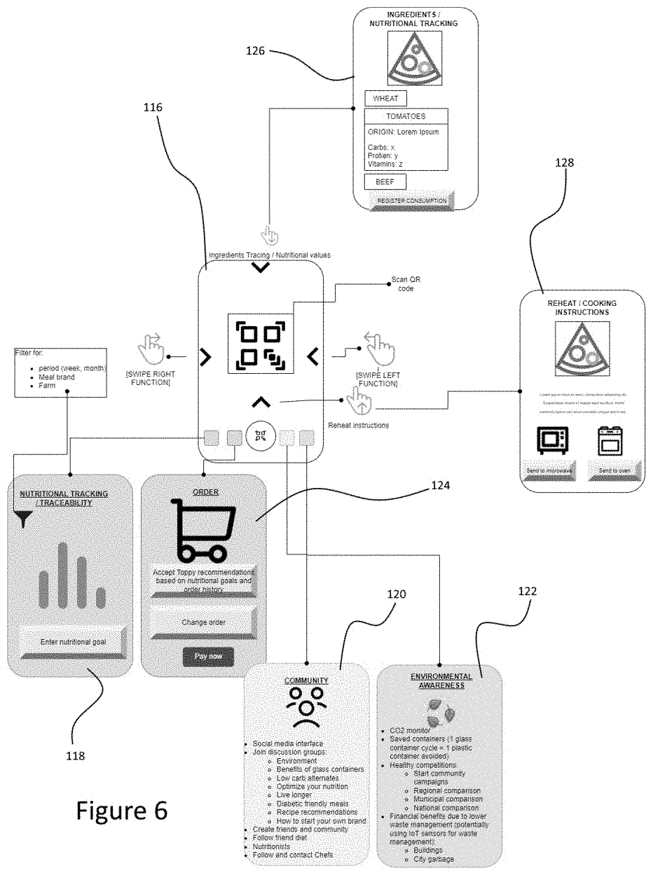

Referring now to FIG. 6 in addition to FIG. 3, in some cases, for example consumers, access to selected data from the database 12 may be via an application 116, for example running on suitably equipped smartphone or web browser or the like (not shown) and capable of scanning the unique permanent identification 20, as discussed above illustratively a QR code or the like, which allows access to information related to the traceable asset 18 such as nutritional information 118 and other related information such as community information 120 and environmental awareness information 122. Additionally, access is provided to an e-commerce system 124 via which products such as food items can be ordered. Additional information can be provided such as information related to ingredients and nutritional tracking 126 as well as reheat instructions or the like 128.

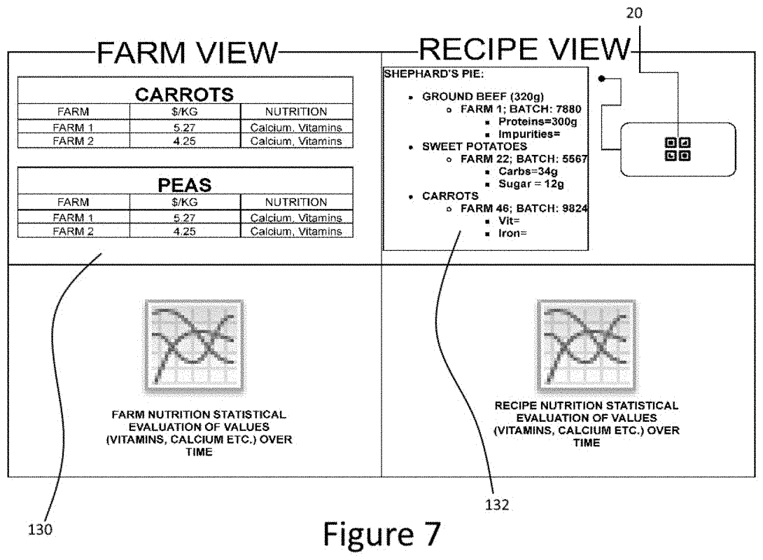

Referring now to FIG. 7 in addition to FIG. 5 and FIG. 3, selecting nutritional information 118 provides for inter alia a display of information related to the source of food items 72 held within a container 58, which can be retrieved by scanning the unique permanent identification 20 of the container 58, as discussed above illustratively a barcode, QR code, RFID or the like. This includes traceabilty information 130 providing for the traceability of ingredients used to prepare the food items 72 or which can be used to prepare a food item by the consumer and according to a recipe 132. In some cases, generic nutritional data for ingredients can be provided. In a particular embodiment, nutritional data is attached to batch lots and can be derived from the farm of origin of the food batch, for example to include information such as whether the ingredients are organic or any chemicals or pesticides or the like which may or may not have been used in cultivating the ingredients in question. This data is illustratively derived by sourcing directly from food producers with established quality controls and includes inter alia periodic testing of ingredients to determine nutritional values, which may be subsequently provided to the food consumers via the application 116. Additionally, in some embodiments other reusable containers 58 may be used for transporting ingredients between food suppliers such as farms and container users 58. In an effort to provide, for example, farm to plate tracking information, by associating the nutritional data ingredients placed in a given container 58 with the container's unique permanent identification 20, the nutritional data as well as the source of the ingredients can be made available by the container users for inclusion in the nutritional data of recipes used to prepare the food orders.

Although the present invention has been described hereinabove by way of specific embodiments thereof, it can be modified, without departing from the spirit and nature of the subject invention as defined in the appended claims.

1. A method for tracking a plurality of reusable item containers throughout a container life span, comprising:
during a container supply stage:
applying a unique permanent identification to each of the containers;
dividing each of said identified containers into one of a plurality of container sets;
assigning each of said container sets to a respective one of a plurality of container users;
populating a database with data related to each of said assigned containers, wherein for each identified container said related data comprises said unique permanent identification and related static or dynamic data;
during a container use stage:
receiving an item order from a consumer at a container user, said order comprising at least one ordered item;
selecting at least one of said containers and packing said at least one ordered item in said at least one selected container;
shipping said at least one packed container to the consumer;
delivering said at least one shipped container to the consumer;
returning said at least one received container; and
receiving said at least one returned container at the container user;
wherein a status and location of each of said containers in a container set assigned to a container user are available upon request from the assigned container user.

2. The method of claim 1, wherein said returning further comprises refurbishing said received container.

3. The method of claim 2, wherein said returning comprises returning said at least one received container to the container user and wherein said refurbishing comprises the container user refurbishing said at least one returned container.

4. The method of claim 2, wherein said assigning comprises supplying each of said container sets to the container users by a container supplier and further wherein said returning comprises returning said at least one received container to the container supplier and wherein said refurbishing comprises the container supplier refurbishing said at least one received container and resupplying said refurbished container to one of the plurality of container users.

5. The method of claim 1, wherein said related static or dynamic data comprises at least one of said assigned container user, a status of said container, and a current location of said container.

6. The method of claim 3, wherein during said container supply stage each of said container subsets are supplied to their respective container users and for each of said supplied containers, said related data is updated such that said status is ready for use and said location is at the container user.

7. The method of claim 3, wherein selecting at least one of said containers comprises selecting at least one said containers comprising a status of ready for use.

8. The method of claim 3, wherein shipping said at least one packed container to the consumer further comprises, for each of said shipped containers, updating said related data such that said status is in use and said location is in transit.

9. The method of claim 3, wherein delivering said at least one shipped container to the food consumer further comprises, updating said related data such that said location is at food consumer.

10. The method of claim 3, wherein returning said at least one received container to the container user further comprises, for each of said returning containers, updating said related data such that said status is used and said location is in transit.

11. The method of claim 3, wherein receiving said at least one returned container at the container user further comprises, for each of said returning containers, updating said related data such that said location is at container user.

12. The method of claim 3, further comprising, following said receiving said at least one returned container at the container user, refurbishing each of said at least one received container and for each of said refurbished containers, updating said related data such that said status is ready for use.

13. The method of claim 1, wherein the container comprises a food container, wherein said item is a food item and wherein the consumer is a food consumer.

14. The method of claim 1, wherein the container comprises one of a reusable container or a reusable bag.

15. The method of claim 14, wherein the reusable container comprises one of a paper container, metal container, plastic container, glass container or container manufactured of other organic materials.

16. The method of claim 1, wherein said location further comprises a geographic location, and further wherein said geographic location is displayed as an icon on a map.

17. The method of claim 1, wherein said assigning further comprises branding each container of said container set according to its respective container user.

18. The method of claim 1, wherein each of said containers comprises a barcode, QR code, RFID or the like comprising said unique permanent identification and said updating comprises reading said barcode, QR Code, RFID or the like with a scanner, deriving said unique permanent identification from said barcode, QR Code, RFID or the like, accessing said database using said derived unique permanent identification and modifying at least one of a status or a location associated with said derived unique permanent identification.

19. The method of claim 13, wherein packing said at least one ordered food item comprises placing said at least one ordered food item in a plurality of reusable containers and placing said plurality of reusable containers in a reusable bag and further wherein said unique permanent identification of each of said plurality of reusable containers is associated with said unique permanent identification of said reusable bag such that scanning said unique permanent identification of said reusable bag displays said unique permanent identification of said reusable containers in said reusable bag.

20. The method of claim 13, wherein said reusable container further comprises a display and further comprising displaying a summary of said at least one ordered food item on said display.

21. The method of claim 20, wherein said display can be used to present one of a brand, a logo, a sponsor and an advertisement.

22. A reusable container method, comprising:
selecting one of a plurality of containers, each of said containers comprising a unique permanent identification;
placing a first item in said selected container;
in a database, associating a description of said first item with said unique permanent identification of said selected container;
using said unique permanent identification, accessing said database and displaying said associated description of said first item on a first display;
removing said first item from said selected container;
placing a second item in said selected container;
in said database, associating a description of said second item with said unique permanent identification of said selected container;
using said unique permanent identification, accessing said database and displaying said associated description of said second item on a second display.

23. The method of claim 22, wherein a first device comprises said first display and a second device comprises said second display and further wherein said first device and said second device are each selected from one of a smartphone, a portable computer and a desktop computer.

24. The method of claim 23, wherein each of said first device and said second device comprises an app for accessing said database and respectively retrieving said description of said first item using said unique permanent identification of said first item and said description of said second item using said unique permanent identification of said second item and respectively displaying said description of said first item on said first display and displaying said description of said second item on said second display.

25. The method of claim 22, wherein when said description of said second item is associated with said unique permanent identification in said database, said association of said description of said first item is no longer associated with said unique permanent identification.

26. The method of claim 22, wherein said first item comprises a first food item, said second item comprises a second food item, said description of said first item comprises a description of said first food item and said description of said second item comprises a description of said second food item.

27. The method of claim 26, wherein said description of said first food item comprises list of ingredients of said first food item and said description of said second food item comprises a list of ingredients of said second food item.

28. A reusable container method, comprising:
selecting a plurality of primary containers, each of said primary containers comprising a unique permanent identification;
placing an item in each of said selected primary containers;
in said database, associating a unique permanent identification of a given one of said selected primary containers with a description of said item placed in said primary given container;
placing each of said selected primary containers in secondary container, said secondary container comprising a unique permanent identification;
in said database, associating said unique permanent identification of said secondary container with said descriptions of each of said items in each of said selected primary containers;
using said unique permanent identification of said secondary container, accessing said database and displaying said descriptions of each of said items in each of said selected primary containers.
